(19) United States
(12) Patent Application Publication
(10) Pub. No.: US 2006/0227135 A1
(43) Pub. Date: Oct. 12, 2006

(54) System and method for N-dimensional parametric analysis

(76) Inventor: Peter W. Johnson, Madison, AL (US)

Correspondence Address: LITMAN LAW OFFICES, LTD, PO BOX 15035, CRYSTAL CITY STATION, ARLINGTON, VA, 22215, US

(21) Appl. No.: 11/094,658

(22) Filed: Mar. 31, 2005

(51) Int. Cl. G06T 17/20

(52) U.S. Cl. 345/423

(57) ABSTRACT

The system and method for n-dimensional parametric analysis solves the problem of finding conditional overlap probabilities for M objects of N dimensions each by decomposing N-dimensional feature spaces into 3-dimensional feature spaces. Intersectors for objects in N-dimensional feature space are used to identify density intersection cubes in the three dimensional feature spaces. Density intersection cubes are split into single density cubic sub-regions that can be associated with other cubic sub-regions of a same density. In association with other single density cubic sub-regions of a same density, the single density cubic sub-regions are recomposed back into an N-dimensional space, becoming single density hyper cubic sub-regions. Ambiguities, among the original M objects of N dimensions may be quantified in terms of the hyper volumes of the single density hyper cubic sub-regions. A method for n-dimensional parametric analysis is implemented in a computer system by a computer program or computer program product.

### BACKGROUND OF THE INVENTION

1. Field of the Invention

The present invention relates to multidimensional data analysis, and more particularly to a system and method for n-dimensional parametric analysis that solves a problem of finding conditional overlap probabilities for M objects of N dimensions each.

2. Description of the Related Art

Problems requiring the analysis of one or more objects each characterized by a multidimensional feature space are relatively common. Among these are object identification or matching tasks. An unknown object may be identified by measuring or quantifying one or more attributes or characteristics of the unknown object and attempting to match these attributes and characteristics to those of known objects. Similarly, an object may be correlated or associated with a class or category of objects having similar attributes and characteristics.

Electronic intelligence presents an example of object identification and matching problems requiring analysis of objects within a multidimensional feature space, and provides a good illustration of a broad class of problems or applications dealing with a domain which can be represented in terms of a set of points, lines, planes, cubes, or hyper-cubes that contain or describe a given distribution of data. A goal of electronic intelligence (ELINT) is, conceptually, rather straight forward. It is desirable to employ a radar signal receiver to receive radar signals from one or more radar emitter, to evaluate certain measurable characteristics of the radar signals, and to identify the one or more radar emitters based on the radar signal characteristics.

In an ELINT database, a library is maintained containing known operational parameters and ranges for known radar emitters. The graph shown in FIG. 1A depicts a library describing two emitters in terms of two operational parameters. A feature space 102 is defined, for a first emitter type, by known operating ranges for parameters X and Y, and a feature space 104 is defined by known operating ranges of parameters X and Y for a second emitter type. An unknown emitter 106 having X and Y parameter values Xₑ and Yₑ may be readily identified as the first emitter type because the measured values Xₑ and Yₑ fall within the feature space 102 known to describe the first emitter type.

Turning to FIG. 1B, feature space 102 and feature space 104B overlap slightly, forming an overlapping region 108. Now, the parameter values Xₑ and Yₑ of the unknown emitter 106 fall within the overlapping region 108, contained within both feature space 102 and feature space 104B. Thus, it cannot be determined, based on available information describing the unknown emitter 106, which type the unknown emitter 106 is. The overlapping region 108 may be referred to as an ambiguity.

It can be recognized that ambiguities may be of particular analytical interest, both in terms of identifying additional resources that may be called on to eliminate an ambiguity (such as an additional measurable operational characteristic that may be used to further define a feature space) and in terms of determining a relative level of need to solve an ambiguity. In the ELINT example, an ambiguity between two different types of friendly surveillance radars may not be worth any expense to solve, while an ambiguity between a friendly surveillance radar and an unfriendly weapon guiding radar may require a solution regardless of cost.

An analytic look at the ambiguities within a set of M feature spaces of N dimensions each begins by quantifying the ambiguities. In the simple example of FIG. 1B, which illustrates a set of two (2) feature spaces of two (2) dimensions each, the ambiguity or overlapping region 108 may be quantified by finding the area of the overlapping region 108. The area of an overlapping region, quantifying an ambiguity, may be further expressed relative to the total area of all feature spaces or to the area of a subset of feature spaces, or as a probability.

The simple 2-dimensional illustration of FIG. 1B itself becomes more complex when expanded from two 2-dimensional feature spaces to a large number M of feature spaces, but ambiguities remain identifiable as overlapping or intersecting regions and remain quantifiable in terms of absolute or relative area. Expanding from the 2-dimensional illustration to a 3-dimensional problem, it can be recognized that the rectangular feature, spaces become cubic spaces, and intersections are quantified in terms of volume rather than area. Expanding further, from 3-dimensional space to N-dimensional space, cubic feature spaces become hyper-cubic and volumetric quantifications of intersections become hyper-volumetric.

A process for quantifying intersections, or ambiguities, among M 3-dimensional feature spaces involves breaking apart the feature spaces, according to intersecting regions, into numerous cubic sub-regions each of a single density, where density refers to the feature space intersectors contained within the sub-region. The concept of density is illustrated, in two dimensions, in FIG. 2, where three overlapping feature spaces 202, 204, and 206 are shown. A first density is the un-overlapped portion of feature space 202. A second density is the un-overlapped portion of feature space 204, and a third density is the un-overlapped portion of feature space 206. A fourth density is the region where all of the feature spaces 202, 204, and 206 intersect. A fifth density is the region occupied by only feature spaces 202 and 204, and so forth. It can be easily visualized that resulting non-rectangular spaces such as the first density may be divided into rectangular sub-regions by extending an edge, or edges, of an intersecting feature space or density.

In three dimensions, a sub-region that is found at the intersection of a first cubic feature space and, a second, intersecting, cubic feature space, provides a reference from which to further divide the first and second feature spaces into additional cubic sub-regions. Fracturing 3-dimensional feature spaces in this manner, into numerous cubic sub-regions, facilitates the volumetric quantification and subsequent analysis of ambiguities. While this technique, referred to as “cuberization”, provides a powerful tool for 3-dimensional problems, it is not readily extendible to work with multi-dimensional spaces.

Thus, a system and method for n-dimensional parametric analysis solving the aforementioned problems is desired.

### SUMMARY OF THE INVENTION

The system and method for n-dimensional parametric analysis solves the problem of finding conditional overlap probabilities for M objects of N dimensions each by decomposing N dimensional feature spaces into 3-dimensional feature spaces, which can be quantified using the technique of “cuberization”. “Cuberized” 3-dimensional objects are recomposed to produce cuberized N-dimensional hyper-cubic objects, from which n-dimensional conditional overlap probabilities may be calculated.

A method for n-dimensional parametric analysis is performed on a general purpose computer system such as a personal computer or the like. An N-dimensional feature space containing a first plurality of objects characterized by a range of N parameters is decomposed into a second plurality of three dimensional feature spaces. Intersectors for each of the objects are found in the N-dimensional feature space. The intersectors are used to identify density intersection cubes among the three dimensional feature spaces. The three dimensional feature spaces are then split, using the intersectors and density intersection cubes, into single density cubic sub-regions.

The single density cubic sub-regions are recomposed, by joining similar cubic sub-regions among different three dimensional feature spaces, into N-dimensional single density hyper cubes. Hyper volumes may be calculated for the N-dimensional single density hyper cubes, thereby quantifying different densities existing in the N-dimensional space.

Thus, a system and method for n-dimensional parametric analysis is shown to solve a problem of finding conditional overlap probabilities for M objects of N dimensions each.

These and other features of the present invention will become readily apparent upon further review of the following specification and drawings.

### BRIEF DESCRIPTION OF THE DRAWINGS

FIG. 1A illustrates an example of non-overlapping two-dimensional feature spaces.

FIG. 1B illustrates an example of overlapping two-dimensional feature spaces.

FIG. 2 illustrates an example of overlapping two-dimensional feature spaces defining multiple density regions.

FIG. 3 is a flowchart of a process for finding N-dimensional hyper-volumes of intersections and densities in M feature spaces of N dimensions each.

FIG. 4 illustrates a multi-dimensional decomposition, cuberization, and cuberized recomposition process described in the flowchart of FIG. 7.

FIG. 5 is a flowchart describing a “cuberization” process.

FIGS. 6A-6E illustrate splitting rules for splitting a feature space into rectangular (or cubic) sections.

FIGS. 7A and 7B illustrate example steps of the cuberization process described in FIG. 4.

FIG. 7C illustrates an example result of the cuberization process described in FIG. 4.

FIG. 8A illustrates an example of intersecting 3-dimensional feature spaces.

FIG. 8B illustrates an example result of cuberizing the intersecting 3-dimensional feature spaces shown in FIG. 8A.

FIG. 9 is a flowchart describing steps for recomposing cubic sub-regions of a given dimensionality into objects of the next higher dimensionality.

FIG. 10 is a flowchart describing steps for determining conditional overlap probabilities using the cuberized, recomposed N-dimensional feature objects.

FIG. 11 is a block diagram of a computer system implementing a method for n-dimensional parametric analysis according to the present invention.

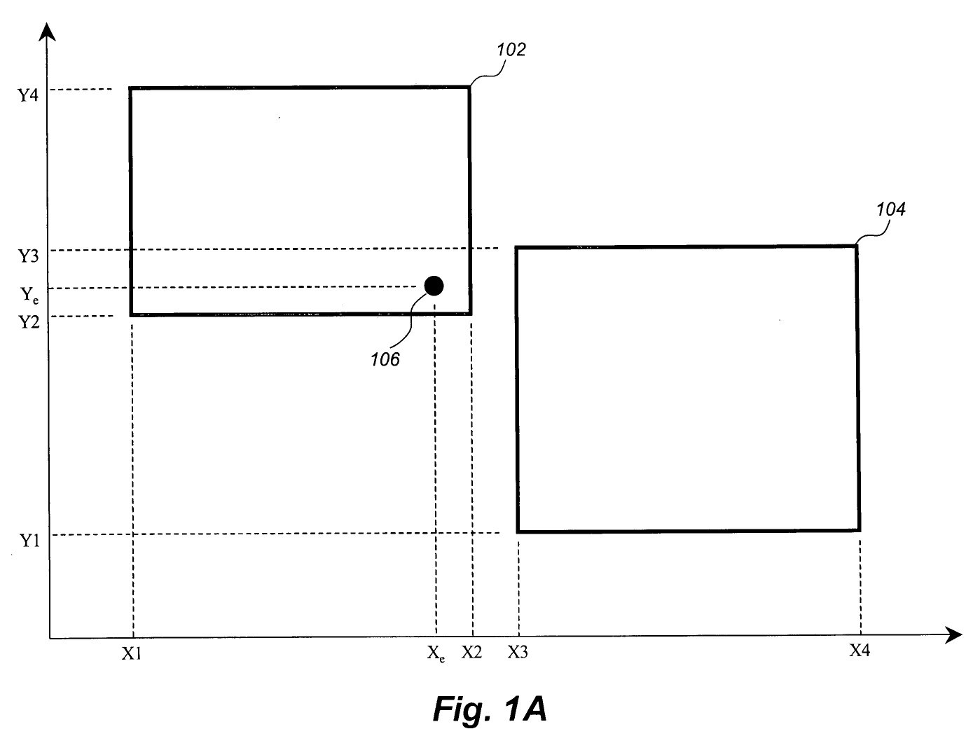

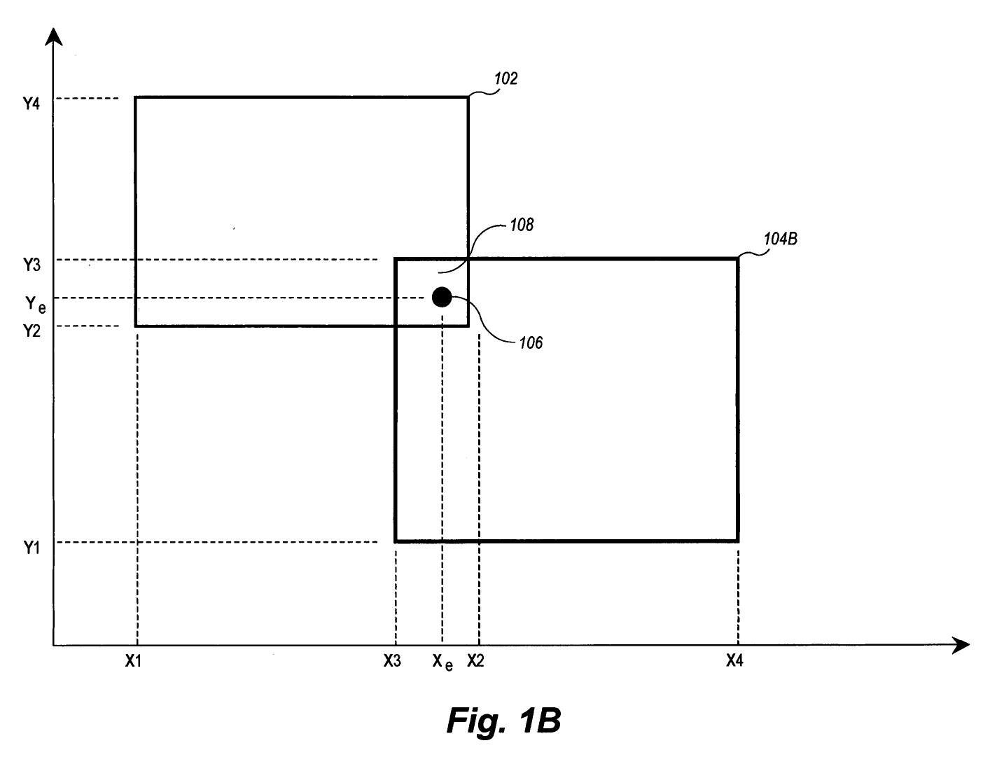

Similar reference characters denote corresponding features consistently throughout the attached drawings.

### DETAILED DESCRIPTION OF THE PREFERRED EMBODIMENT

The present invention is a system and method for n-dimensional parametric analysis. The system and method for n-dimensional parametric analysis solves the problem of finding conditional overlap probabilities for M objects of N dimensions each by decomposing N dimensional feature spaces into 3-dimensional feature spaces, which can be quantified using the technique of “cuberization”. “Cuberized” 3-dimensional objects are recomposed to produce cuberized N-dimensional hyper-cubic objects, from which n-dimensional conditional overlap probabilities may be calculated.

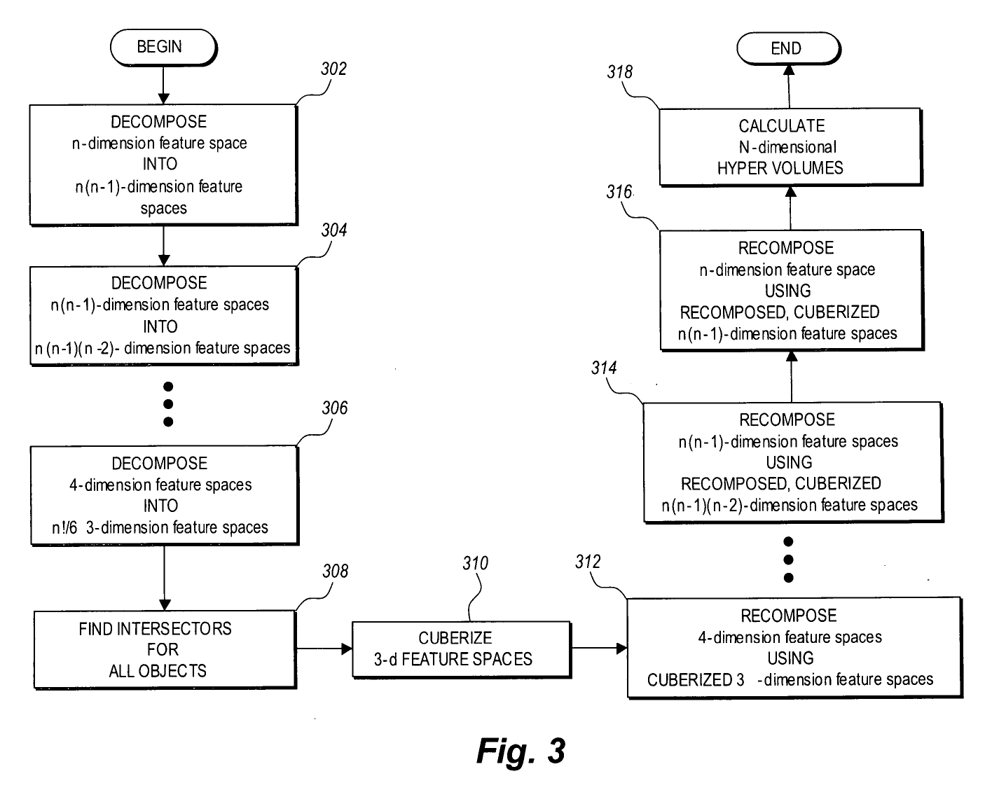

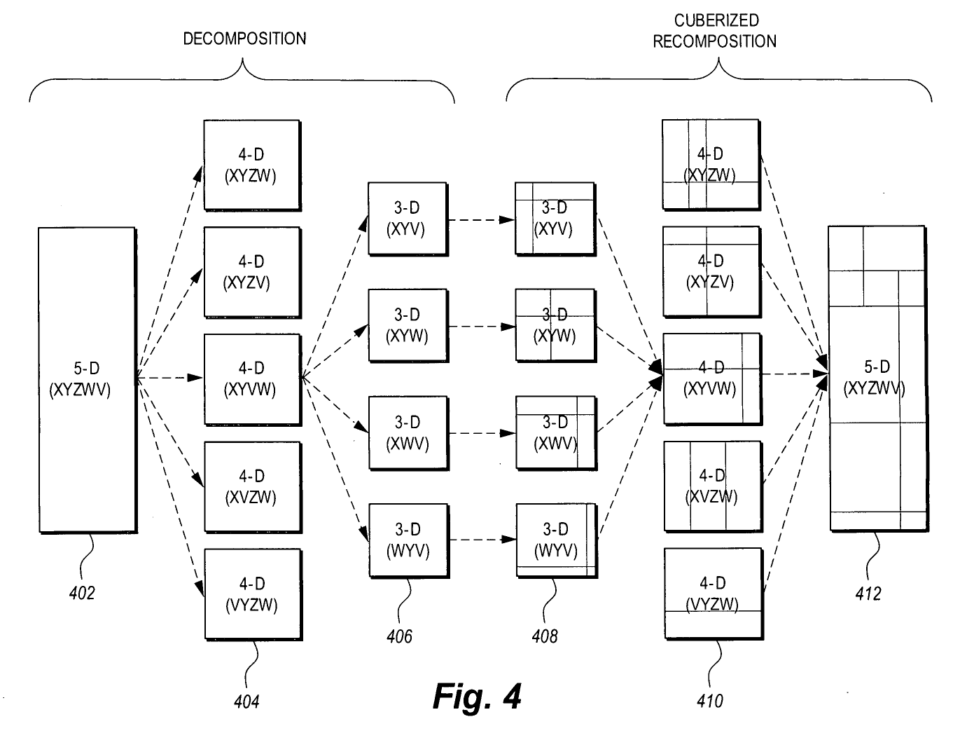

Referring to FIGS. 3 and 4, a method for n-dimensional parametric analysis according to the present invention is described. During a full n-dimensional decomposition, an n-dimensional hypercube, or feature space, is, decomposed into n!/3!, or n!/6, 3-dimensional solids. Note, however, that such a full decomposition creates some redundancies. For example, XYZW and XYZV will each produce identical XYZ feature spaces during decomposition. Thus, by eliminating redundancies, the decomposition process will result in fewer than n!/3! unique 3-dimensional solids.

Decomposition is performed in single-dimensional steps, first decomposing the n-dimensional hypercube into n, (n-1)-dimensional hypercubes (step 302). In the example illustrated in FIG. 4, a 5-dimensional hypercube 402 is decomposed into 5, 4-dimensional hypercubes 404. The n, (n-1)-dimensional hypercubes are next decomposed into n(n-1), (n-2)-dimensional objects (step 304). The decomposition continues until a final decomposition of 4-dimensional hypercubes into 3-dimensional solids (step 306). Referring again to the example in FIG. 4, each of the 5, 4-dimensional objects 404 is further decomposed into 4, 3-dimensional solids 406, ending the decomposition process. An n^{th} dimension is decomposed by first eliminating the n^{th} dimension, and then “rotating” the n^{th} dimension through the remaining dimensions to replace each remaining dimension in turn. This is seen in FIG. 4 as the 5-dimensional hypercube 402 in XYZWV space is decomposed first by eliminating the 5^{th} dimension V to produce XYZW, and then “rotating” the V dimension through the remaining dimensions, replacing each remaining dimension in turn, producing XYZV, XYVW, XVZW, and VYZW. (Note that V is underlined for clarity.)

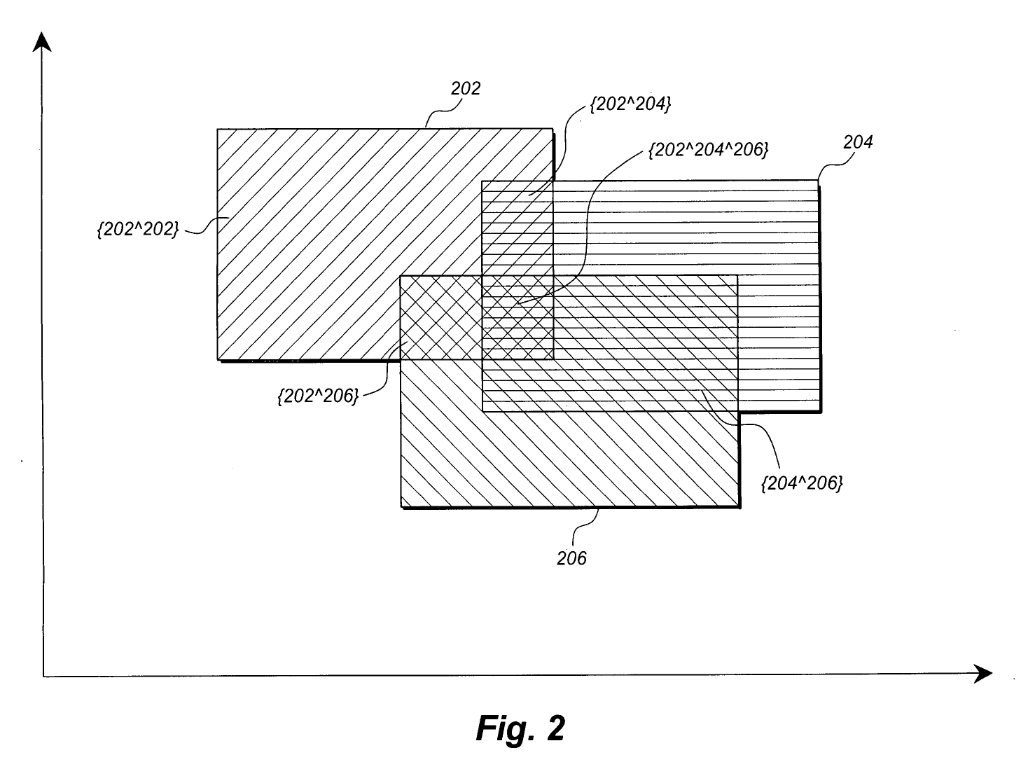

Ambiguities among-the resulting 3-dimensional solids may be quantified using the process of cuberization. Initially, intersectors are found for all of the 3-dimensional solids (step 308). An intersector of a given feature space is simply another feature space that overlaps, or intersects, the given feature space. Referring briefly back to FIG. 2, the feature space 204 is an intersector of the feature space 202 because feature space 204 overlaps feature space 202, creating an intersection or ambiguity. Note that, while the cuberization process is a 3-dimensional process working with cubic feature spaces and their intersections, it will be described and illustrated with reference to the 2-dimensional example of FIG. 2.

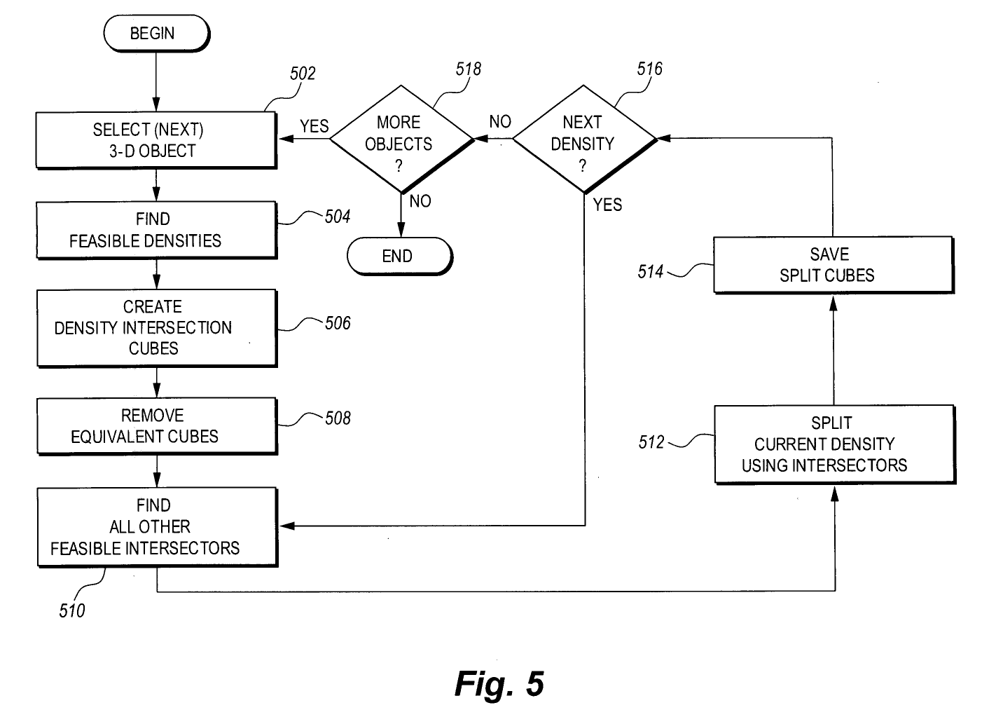

Once the intersectors are identified for all objects, the objects are split into sub-objects that are 1) each a cubic object, and 2) each contain a single density (step 310). The splitting process, or cuberization, performed at step 310 is further described with reference to FIG. 5. The cuberization process is performed for each of the 3-dimensional feature spaces that result from the decomposition process. A 3-dimensional feature space is selected (step 502), and all of its intersectors identified. Referring to the example of FIG. 2, the feature space 202 is first selected, with feature spaces 204 and 206 its intersectors.

Each density contained within the selected feature space is identified, based on the intersectors (step 504). Density intersection cubes are defined for each region where an intersector or intersectors overlap the selected 3-dimensional feature space (step 506). Note that, for the purpose of defining density intersection cubes, the selected 3-dimensional feature space is considered to intersect itself, creating a density intersection cube equivalent to the selected 3-dimensional feature space. Thus, referring to FIG. 2, four (4) density intersection cubes are found contained within the feature space 202. These are 1) the intersection of the feature space 202 with itself (designated {202ˆ202}); 2) the intersection of feature space 202 with feature space 204 (designated {202ˆ204}) ; 3) the intersection of feature space 202 with feature space 206 (designated {202ˆ206}); and 4) the intersection of feature space 202 with feature spaces 204 and 206 (designated {202ˆ204ˆ206}). Equivalent cubes of lesser densities are eliminated (step 508).

The cuberization process continues for each of the density intersection cubes found in step 506, one at a time. All remaining intersectors (step 510) are found for a density intersection cube, and the density intersection cube is split by each intersector sequentially. The density intersection cube is split, according to a uniform set of splitting rules, into cubic sub-regions (step 512).

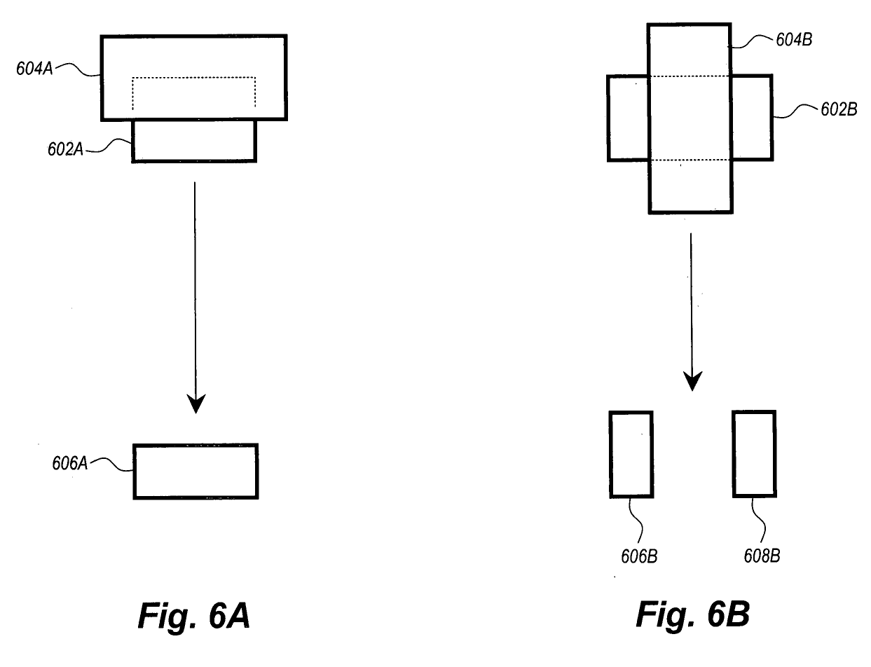

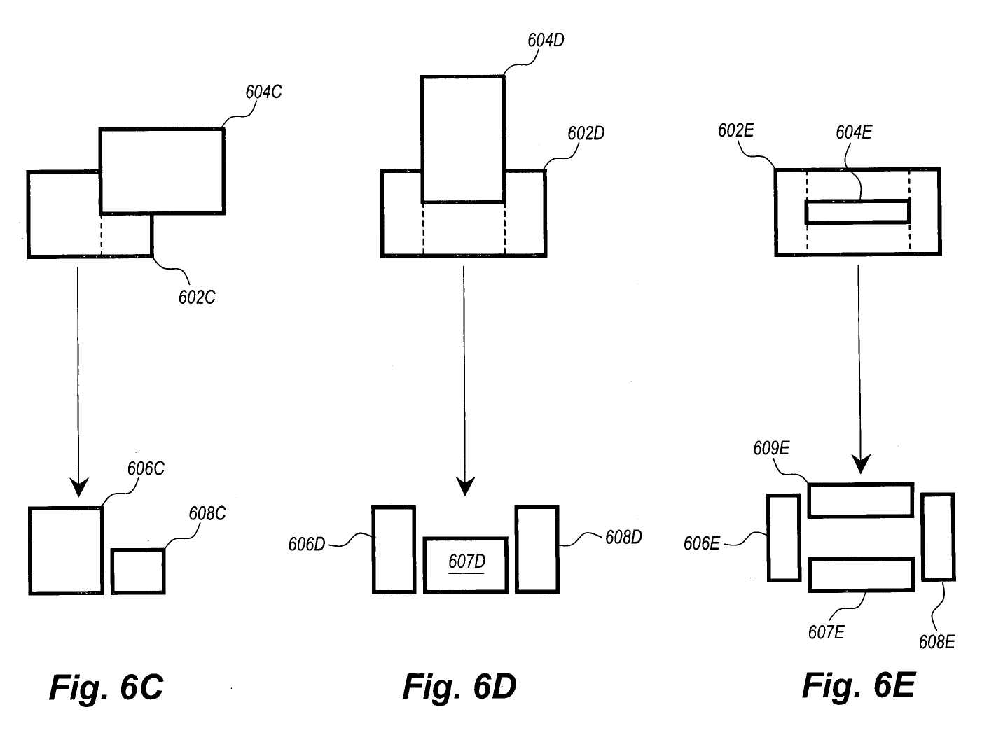

Splitting rules are illustrated 2-dimensionally in FIGS. 6A-6E. In FIGS. 6A and 6B, a density intersection cube (a rectangle, in two dimensions) is obviously split by an intersector that has one or more edges that entirely traverse the density intersection cube, “splitting off” a portion. In FIG. 6A, a density intersection cube 602A is overlayed by an intersector 604A such that a single cubic sub-region 606A is split off from the density intersection cube 602A. In FIG. 6B, a density intersection cube 602B is overlayed by an intersector 604B such that a portion of the density intersection cube 602B extends from either side of the intersector 604B, splitting off cubic sub-regions 606B and 608B.

In FIGS. 6C-6E, a density intersection cube is intersected by an intersector such that at least a portion of adjacent sides of the intersector fall within the density intersection cube but do not entirely split the density intersection cube. In each such case, it is apparent that the density intersection cube may be divided into cubic sub-regions in more than one way. Here, uniformity is desired and so a repeatable rule must be adopted. In the illustrated examples, a “vertical” rule is used wherein the density intersection cube is split by extensions of vertical edges of the intersector. Alternatively, a “horizontal” rule, or a repeatable “hybrid” rule could be employed.

In FIG. 6C, a corner of an intersector 604C overlies the density intersection cube 602C, resulting in an irregular (non-rectangular or non-cubic) shape of the un-intersected portion of the density intersection cube 602C. An extension of the vertical edge of the intersecting corner splits the un-intersected portion of the density intersection cube 602C into cubic sub-regions 606C and 608C. In FIG. 6D, an end of an intersector 604D overlies the density intersection cube 602D. Here, extending two vertical edges splits the un-intersected portion of the density intersection cube 602D into three cubic sub-regions 606D, 607D, and 608D. In FIG. 6E, an intersector 604E is entirely contained within the density intersection cube 602E. Again, the density intersection cube 602E is split by extending vertical edges of the intersector 604E. This time, four cubic sub-regions 606E, 607E, 608E, and 609E are created.

It should be noted that several additional intersections exist symmetrically to those shown. For example, while FIG. 6C shows an intersector 604C overlying the top right-hand corner of the density intersection cube 602C, it can be understood that a similar rule applies to the symmetric cases wherein an intersector 604C overlies the bottom right-hand corner, the top left-hand corner, or the bottom left-hand corner of the density intersection cube 602C. Accounting for all such overlaps, there are sixteen (16) ways for a given rectangle to intersect another rectangle in 2-dimensions. It can be understood that the 2-dimensional splitting rule illustrations are readily extended to 3-dimensional problems by, essentially, substituting cubes for rectangles, and substituting cubic faces for rectangular edges. A face of an intersector is extended as a plane to split a density intersection cube in 3-dimensions. Accounting for all types of overlap, the sixteen possibilities in 2-dimensions become sixty-four (64) in 3-dimensions.

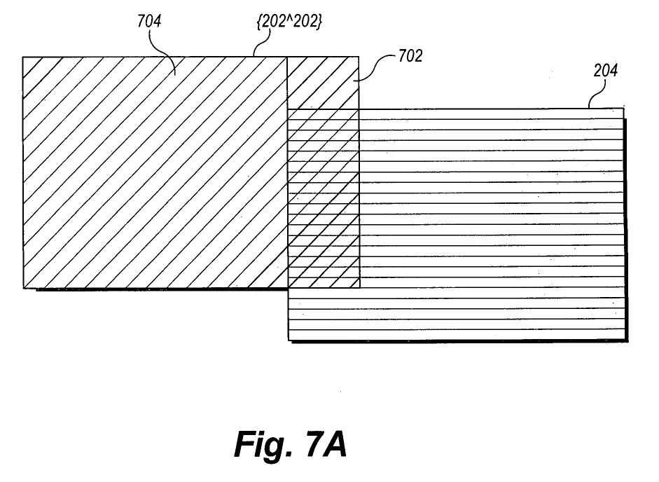

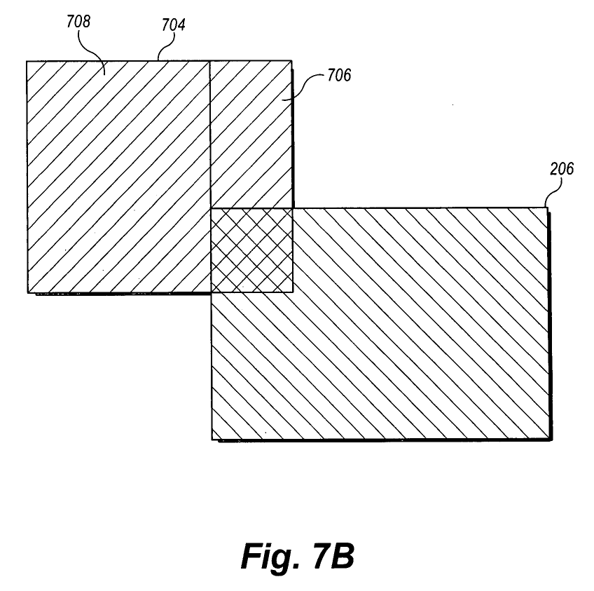

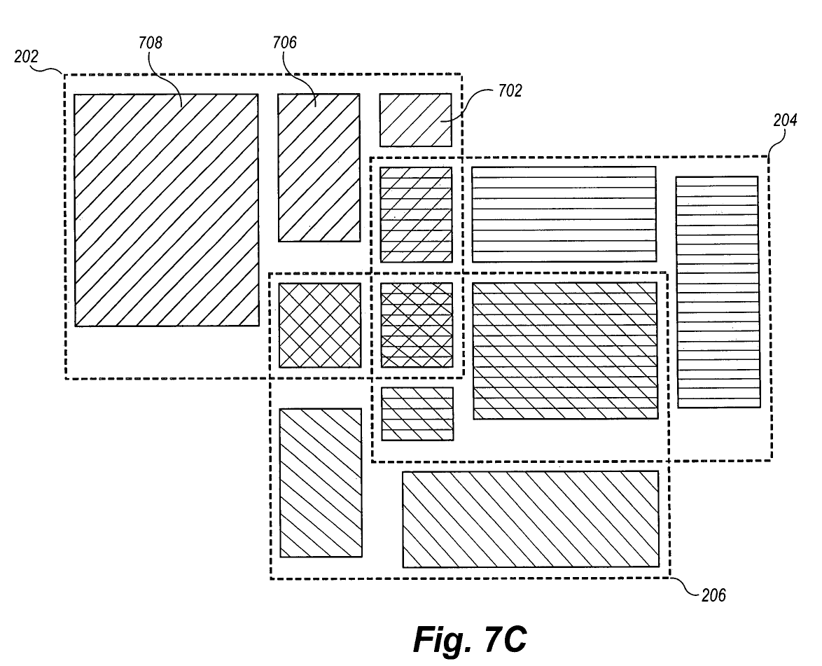

Returning to the task of splitting a density intersection cube cubic sub-regions (step 512), this process is illustrated in FIGS. 7A and 7B. Again, while the illustration is 2-dimensional, its extension to 3 dimensions is readily apparent. Recalling the density intersection cubes ({202ˆ202}, {202ˆ204}, {202ˆ206}, and {202ˆ204ˆ206}) found at step 502 for the example of FIG. 2, FIG. 7A now shows the density intersection cube {202ˆ202} overlaid by feature space 204 as a current intersector. Following the vertical splitting rule, the un-overlapped portion of the density intersection cube {202ˆ202} is split into two cubic sub-regions 702 and 704 by extending a vertical edge of the intersector (feature space 204).

In FIG. 7B, again recalling the example of FIG. 2, feature space 206 is selected as the current intersector. Note that, at this point, the current intersector (feature space 206) only intersects with the cubic sub-region 704 already split apart from the density intersection cube {202ˆ202}. Again, two cubic sub-regions (706 and 708) are formed.

Following the splitting of a density intersection cube, the cubic sub-regions are saved (step 512) and a next density intersection cube is selected and split, until all of the density intersection cubes for the current feature space have been split (at 516). Once all of the density intersection cubes for a current feature space have been split, a next feature space is selected, returning to step 502, until there are no more feature spaces (at 518).

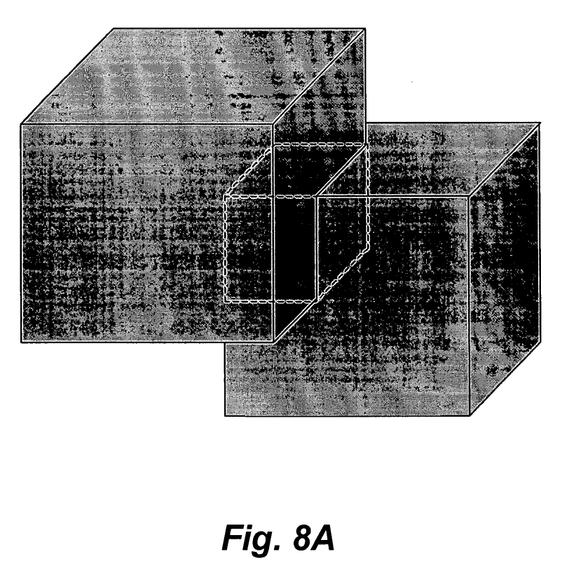

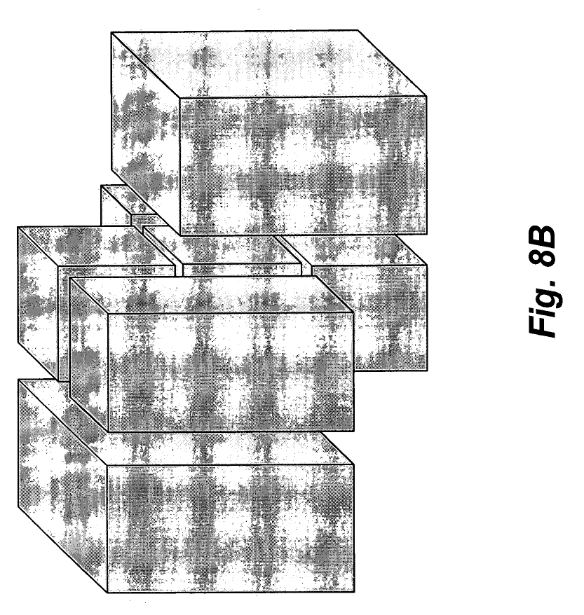

FIG. 7C shows the completed cuberization of the 2-dimensional example presented in FIG. 2. Referring to FIGS. 8A and 8B, a 3-dimensional example is shown of two intersecting cubes (FIG. 8A) and their resulting cuberization (FIG. 8B).

Returning now to FIG. 3, the 3-dimensional cubic sub-regions resulting from the cuberization process of step 310 are recomposed into cuberized N-dimensional hypercubes. As with the decomposition process, the recomposition is performed one dimension at a time, beginning by recomposing the cuberized 3-dimensional sub-regions into cuberized 4-dimensional objects (step 312). Each 3-dimensional sub-region of each cuberized 3-dimensional feature space must be associated with its remaining (N-3)-dimensions. Because all of the 3-dimensional feature spaces are cuberized according to the same rules, it follows that every sub-region can be matched to its missing dimensions, one at a time, until restored to its full N-dimensional space.

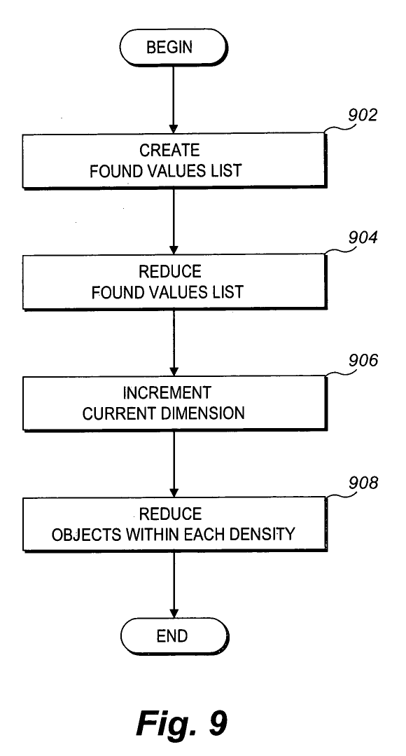

A process for recomposing a dimension into a next higher dimension is described with reference to FIG. 9. A sub-region of the 3-dimensional feature space of XYZ can be associated with its correct W dimension by finding a sub-region within the XYW space having identical X and Y ranges. A list of such matching sub-ranges (referred to as a found values list) is generated (at step 902). The found values list represents a set of potential objects of the next higher dimension.

The found values list may be reduced (step 904) by eliminating duplicate sub-regions, sub-regions which have exact partitions, and sub-regions that are fully contained within other sub-regions (sub-regions that are contained within another sub-region). Objects of the next higher dimensionality are created from the sub-regions left on the found values list (step 906). For example, the W range of such a matching sub-region may be used to expand the XYZ sub-region, along with the W range, to a 4-dimensional object in the XYZW space. The resulting objects, now in the next higher dimension, are again reduced by eliminating duplicates, exact partition enclosures, and subsets (step 908). This process is performed for all of the 3-dimensional sub-regions created by the cuberization process to recompose cuberized 4-dimensional objects.

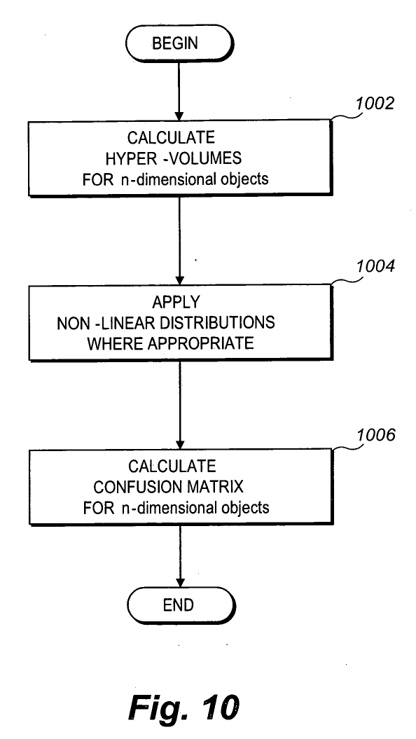

Returning again to FIG. 3, recomposition is repeated until the original N-dimensions are restored (steps 314, 316). The cuberized N-dimensional objects may be used to determine conditional overlap probabilities for the original M feature spaces of N dimensions each (step 318). A process for determining conditional overlap probabilities for the original M feature spaces of N dimensions each is described with reference to FIG. 10. Initially, hyper-volumes are calculated for each of the N-dimensional cuberized objects (step 1002). Because the original boundaries (or range) for a given dimension of a feature space may not be representative of an expected distribution of values or samples within the range, a non-linear distribution may be applied (step 1004). A conditional overlap probability for a given ambiguity may be determined as a ratio of the hyper-volume of the N-dimensional cuberized object derived from densities that are representative of the ambiguity versus the hyper-volume of another feature space (or spaces) of interest (step 1006).

Thus, a process has been described wherein conditional overlap probabilities for N-dimensional objects can be computed using N-dimensional hyper-cubes. This process can serve as the basis for many different N-dimensional parameter analysis functions where a domain-specific feature space is used to describe the domain-specific problem. The conditional probabilities can be utilized for real- and non-real-time object identification and classification. Additionally, the conditional overlap probabilities may be useful in multiple sensor data fusion problems such as object correlation and tracking. In multiple sensor data fusion problems, parameter ranges are introduced by sensor error, discrepancies or differences among multiple sensors each measuring a parameter, or uncertainties defined by covariance estimates.

Other domains of application include data mining, weather applications, radar applications, sonar applications, voice recognition, imaging, stock market analysis, market analysis, medical diagnostics, fingerprinting and facial identification, genetics, and biology, to name a few. More generally stated, applications include any domain which can be represented in terms of points, lines, planes, cubes, and hyper-cubes, with or without non-linear parameter range distributions.

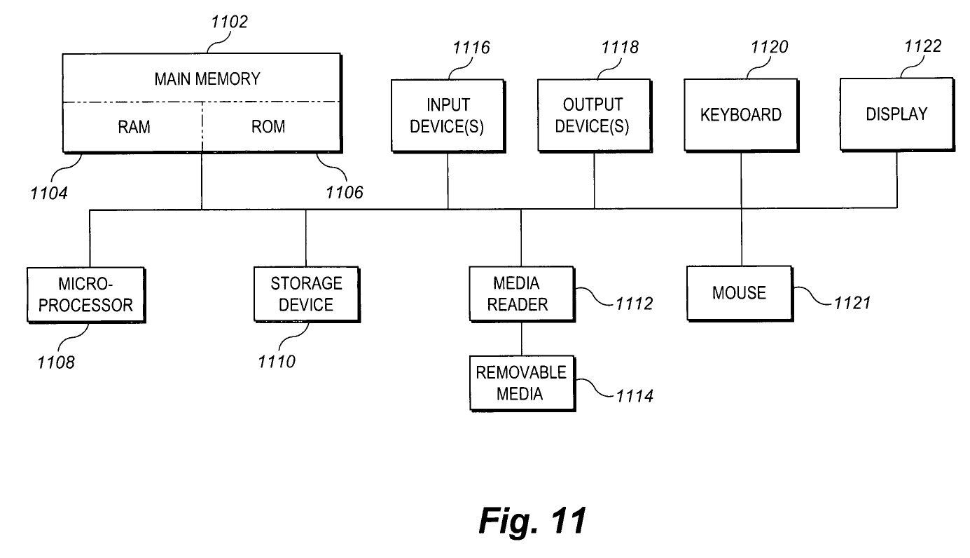

The method for n-dimensional parametric analysis described herein is performed in a system for n-dimensional parametric analysis comprising a general computer system, such as a personal computer or the like generally as illustrated in FIG. 11. Such a computer system generally comprises a microprocessor 1108 connected by a bus to an area of main memory 1102, comprising both random access memory (RAM) 1104, and read only memory (ROM) 1106, and a storage device 1110 such as a disk storage device having means for reading a coded set of program instructions on a computer readable medium which may be loaded into the main memory 1102 and executed by the microprocessor 1108. The storage device 1110 preferably has a large storage capacity to provide for the storage of a database describing the N-dimensional feature spaces. Additional storage devices may be provided, such as a media reader 1112 for reading computer program code or data from a removable storage medium 1114, such as a removable disk drive, CD-ROM drive, or the like.

The computer system typically includes means for providing a user interface, such as a keyboard 1120, a cursor or pointing device such as a mouse 1121, and a display device 1122. Additional input devices 1116 and output devices 1118 are often included in a general purpose or personal computer system.

A computer program comprising a set of computer instructions for performing the method for n-dimensional parametric analysis may be stored by the storage device 1110 to be loaded into the main memory 1102 for execution. Alternatively, a computer program product comprising a removable storage medium 1114 readable by the media reader 1112 and having computer instructions for performing the method for n-dimensional parametric analysis stored thereon may be loaded into the media reader 1112, and the computer program instructions read for execution.

In addition to instructions for performing a method for n-dimensional parametric analysis, the computer program may include instructions for generating a database of objects represented as a set of points, lines, planes, cubes, or hyper-cubes that contain or describe a given distribution of data of interest to a particular problem domain. The computer program may also include instructions for importing such a database from an external source.

The computer program may also include instructions for representing the database, final results of hyper volume calculations, final results of conditional overlap probability calculations, intermediate results, and other relevant data in a graphic, textual, or tabular form. It may be desirable, for example to view the decomposed 3-dimensional objects, density intersection cubes, or single density cubic sub-regions. Additionally, intermediate and final results may be represented in histogram, bar graph, pie chart, or other formats.

It is to be understood that the present invention is not limited to the embodiment described above, but encompasses any and all embodiments within the scope of the following claims.

I claim:

1. A method for n-dimensional parametric analysis, comprising the steps of:
decomposing an N-dimensional feature space containing a first plurality of objects into a second plurality of three dimensional feature spaces;
finding intersectors for each of said objects in said N-dimensional feature space;
using said intersectors to identify density intersection cubes in said three dimensional feature spaces;
splitting said density intersection cubes into single density cubic sub-regions;
recomposing said single density cubic sub-regions into N-dimensional single density hyper cubes; and
calculating hyper volumes for said N-dimensional single density hyper cubes.

2. The method of claim 1, further comprising the step of using said hyper volumes to quantify intersections among said first plurality of objects.

3. The method of claim 1, further comprising the step of using said hyper volumes to calculate conditional overlap probabilities for said first plurality of objects.

4. The method of claim 3, further comprising the step of creating a graphical display depicting said conditional overlap probabilities.

5. The method of claim 1, further comprising the step of creating a graphical display depicting said hyper volumes.

6. The method of claim 1, wherein said N-dimensional feature space is represented in a database.

7. The method of claim 6, further comprising the step of entering a representation of said N-dimensional feature space into a database.

8. The method of claim 1, further comprising the step of creating a graphical display of said three dimensional feature spaces.

9. The method of claim 1, further comprising the step of creating a graphical display of said single density cubic, sub-regions.

10. A computer program product that includes a medium readable by a processor, the medium having stored thereon a set of instructions for performing a method for n-dimensional parametric analysis, the set of instructions comprising:
a first sequence of instructions for decomposing an N-dimensional feature space containing a first plurality of objects into a second plurality of three dimensional feature spaces;
a second sequence of instructions for finding intersectors for each of said objects in said N-dimensional feature space;
a third sequence of instructions for using said intersectors to identify density intersection cubes in said three dimensional feature spaces;
a fourth sequence of instructions for splitting said density intersection cubes into- single density cubic sub-regions;
a fifth sequence of instructions for recomposing said single density cubic sub-regions into N-dimensional single density hyper cubes; and
a sixth sequence of instructions -for calculating hyper volumes for said N-dimensional single density hyper cubes.

11. The computer program product of claim 10, further comprising a sequence of instructions for using said hyper volumes to quantify intersections among said first plurality of objects.

12. The computer program product of claim 10, further comprising a sequence of instructions for using said hyper volumes to calculate conditional overlap probabilities for said first plurality of objects.

13. The computer program product of claim 12, further comprising a sequence of instructions for creating a graphical display depicting said conditional overlap probabilities.

14. The computer program product of claim 10, further comprising a sequence of instructions for creating a graphical display depicting said hyper volumes.

15. The computer program product of claim 10, further comprising a sequence of instructions for representing said N-dimensional feature space in a database.

16. The computer program product of claim 15, wherein said sequence of instructions for representing said N-dimensional feature space in a database further comprises a sequence of instructions for accepting a representation of said N-dimensional feature space from an external source.

17. The computer program product of claim 10, further comprising a sequence of instructions for creating a graphical display of said three dimensional feature spaces.

18. The computer program product of claim 10, further comprising a sequence of instructions for creating a graphical display of said single density cubic sub-regions.
